(19) United States
(12) Patent Application Publication
(10) Pub. No.: US 2026/0187355 A1
(43) Pub. Date: Jul. 2, 2026

(54) GUIDED MACHINE LEARNING MODEL CONVERSATION DEFINITION

(71) Applicant: Microsoft Technology Licensing, LLC, Redmond, WA (US)

(72) Inventors: Dasha METROPOLITANSKY, Cambridge, MA (US); Christine YANG, Cambridge, MA (US); Natalie Gilbert ISAK, Cambridge, MA (US); David Jan KOLECZEK, Southwick, MA (US); Brian Scott KRABACH, Snohomish, WA (US); Soundararajan SRINIVASAN, Belmont, MA (US); Keegan CHOUDHURY, Seattle, WA (US)

(73) Assignee: Microsoft Technology Licensing, LLC, Redmond, WA (US)

(21) Appl. No.: 19/003,450

(22) Filed: Dec. 27, 2024

(51) Int. Cl. G06F 40/174; G06F 16/3329; G06F 40/186

(52) U.S. Cl. CPC G06F 40/174; G06F 16/33295; G06F 40/186

(57) ABSTRACT

A computing system including one or more processing devices configured to compute a guided machine learning (ML) model conversation definition. Computing the guided ML model conversation definition includes iteratively computing definition components over development-time conversational turns exchanged between a developer and a generative language model at a developer interface. The definition components include one or more output generation rules and a fillable template. The one or more processing devices are further configured to execute a guided conversation between a user and the generative language model as specified by the definition components included in the guided ML model conversation definition. Executing the guided conversation includes exchanging runtime conversational turns between the user and the generative language model at a user interface. Executing the guided conversation further includes filling the fillable template based at least in part on the runtime conversational turns. Executing the guided conversation further includes outputting the filled template.

### BACKGROUND

Some recently developed machine learning (ML) models, including large language models (LLMs), small language models (SLMs) and large multimodal models (LMMs), display advanced natural language processing capabilities. These ML models have accordingly been incorporated into a variety of workflows that include semantic modeling and generation of natural-language text. For example, LLMs, SLMs, and LMMs have been used in assistant applications in which an ML model is incorporated into a larger ML system along with scaffolding logic that determines when calls to the ML model are performed. In these assistant applications, a user provides natural-language instructions to an ML model, which then performs a task outside the conversation with the user based on those natural-language instructions.

### SUMMARY

According to one aspect of the present disclosure, a computing system is provided, including one or more processing devices configured to compute a guided machine learning (ML) model conversation definition. Computing the guided ML model conversation definition includes iteratively computing a plurality of definition components over a plurality of development-time conversational turns exchanged between a developer and a generative language model at a developer interface. The definition components include one or more output generation rules and a fillable template. The one or more processing devices are further configured to execute a guided conversation between a user and the generative language model as specified by the definition components included in the guided ML model conversation definition. Executing the guided conversation includes exchanging a plurality of runtime conversational turns between the user and the generative language model at a user interface. Executing the guided conversation further includes filling the fillable template based at least in part on the plurality of runtime conversational turns. Executing the guided conversation further includes outputting the filled template.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including a developer computing device and a server computing device at which one or more processing devices are configured to compute a guided machine learning (ML) model conversation definition, according to one example embodiment.

FIG. 2A schematically shows the computing system when the one or more processing devices of the server computing device are configured to execute a guided conversation between a generative language model and a user of a user computing device, according to the example of FIG. 1.

FIG. 2B schematically shows the user computing device and the server computing device when the one or more processing devices of the server computing device are configured to fill a fillable template, according to the example of FIG. 2A.

FIG. 3 schematically shows the developer computing device and the server computing device in an example in which the one or more processing devices are further configured to receive an unstructured text document at the developer interface during computation of the guided ML model conversation definition, according to the example of FIG. 1.

FIG. 4 schematically shows an example conversation flow descriptor structured as a finite state machine, according to the example of FIG. 1.

FIG. 5 schematically shows an example definition component ordering in which the definition components of the guided ML model conversation definition are generated, according to the example of FIG. 1.

FIG. 6 schematically shows the server computing device and the user computing device in an example in which the one or more processing devices are further configured to generate a guided conversation agenda during execution of the guided conversation, according to the example of FIG. 2A.

FIG. 7 schematically shows the server computing device and the user computing device in an example in which the one or more processing devices are further configured to execute format checking logic, according to the example of FIG. 2B.

FIG. 8 schematically shows the user computing device and the server computing device in an example in which the one or more processing devices are further configured to perform a review of the filled template at the generative language model, according to the example of FIG. 2B.

FIG. 9A shows a flowchart of a method for use with a computing system to compute and execute a guided ML model conversation definition, according to the example of FIG. 1.

FIGS. 9B-9F show additional steps of the method of FIG. 9A that may be performed in some examples.

FIG. 10 shows a schematic view of an example computing environment in which the computing system of FIG. 1 may be instantiated.

### DETAILED DESCRIPTION

In an ML assistant application, a user and an ML model may exchange conversational turns over a user interface. The ML model responds to user inputs according to a framework specified by a developer of the ML assistant application. That framework may include one or more prompt fragments that are input into a context window of the ML model along with the user input. The framework may further include scaffolding logic that may preprocess inputs to the ML model, postprocess outputs of the ML model, and/or determine when calls to the ML model are made.

When developing an ML assistant application according to existing approaches, the developer constructs the scaffolding logic and writes the prompt fragments. Although the developer may use an ML model to perform some stages of this process, such as generating code for specific functions included in the scaffolding logic, other features of the guided conversation such as its overarching structure are more difficult to generate at an ML model using existing techniques. Thus, constructing the ML assistant application may still be cumbersome for the developer. Development of the ML assistant application using existing methods may also rely on domain knowledge on the part of the developer regarding what prompting techniques elicit intended behaviors from the ML model used in the application.

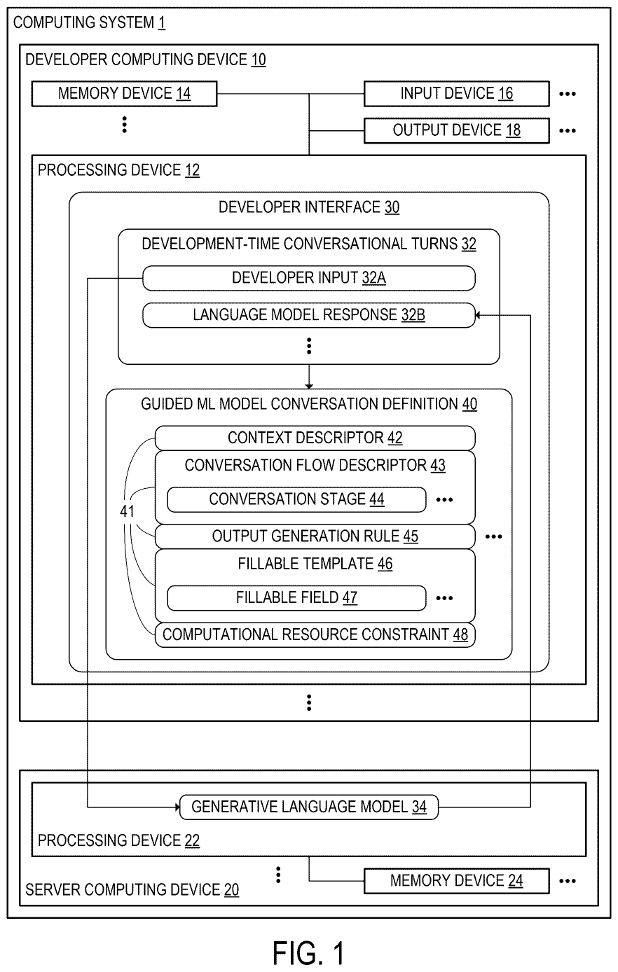

In order to address the above challenges, a computing system 1 is provided, as depicted in FIG. 1 according to one example embodiment. The computing system 1 includes one or more processing devices, which are shown in this example as one or more processing devices 12 included in a developer computing device 10 and one or more processing devices 22 included in a server computing device 20. The processing devices 12 and 22 may, for example, include one or more central processing units (CPUs), graphics processing units (GPUs), neural processing units (NPUs), and/or other types of hardware accelerators. The developer computing device 10 of FIG. 1 further includes one or more memory devices 14, and the server computing device 20 further includes one or more memory devices 24. The developer computing device 10 further includes one or more input devices 16 and one or more output devices 18.

In some examples, the server computing device 20 is located in a data center and is configured to communicate with a remotely located developer computing device 10 over a network. The computing processes discussed herein as being performed at the server computing device 20 may, for example, be performed at a plurality of server computing devices 20 located in the data center. In other examples, the developer computing device 10 and the server computing device 20 may be instantiated as a single physical computing device.

The one or more processing devices 12 of the developer computing device 10 are configured to execute a developer interface 30. The developer interacts with the developer interface 30 using the one or more input devices 16 and the one or more output devices 18. For example, the developer interface 30 may be a graphical user interface (GUI).

At the developer interface 30, the one or more processing devices 12 are configured to compute a guided ML model conversation definition 40. The guided ML model conversation definition 40 is a framework that specifies properties of a guided conversation performed between a generative language model 34 and an end user. As discussed in further detail below, the guided ML model conversation definition 40 includes a plurality of definition components 41.

The guided ML model conversation definition 40 is computed over a plurality of development-time conversational turns 32 exchanged between the developer and the generative language model 34 at the developer interface 30. Each of the development-time conversational turns 32 is developer input 32A or a language model response 32B. In the example of FIG. 1, the generative language model 34, which may be an LLM or an LMM, is executed at the one or more processing devices 22 of the server computing device 20. One or more of the definition components 41 are computed at the generative language model 32. In addition, one or more of the definition components 41 may be received as a developer input 32A. The processing devices 12 and 22 are accordingly configured to iteratively compute the definition components 41 over the plurality of development-time conversational turns 32.

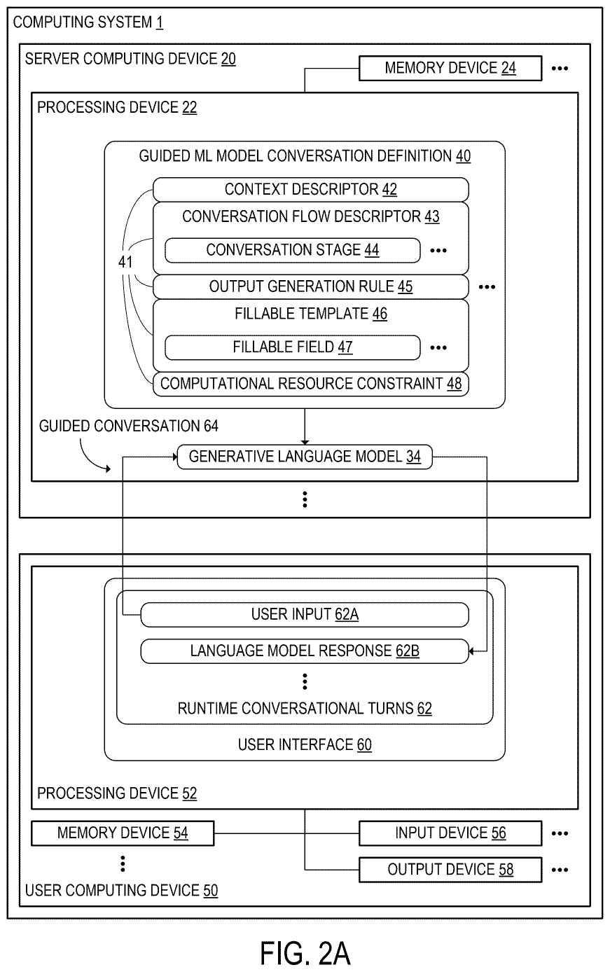

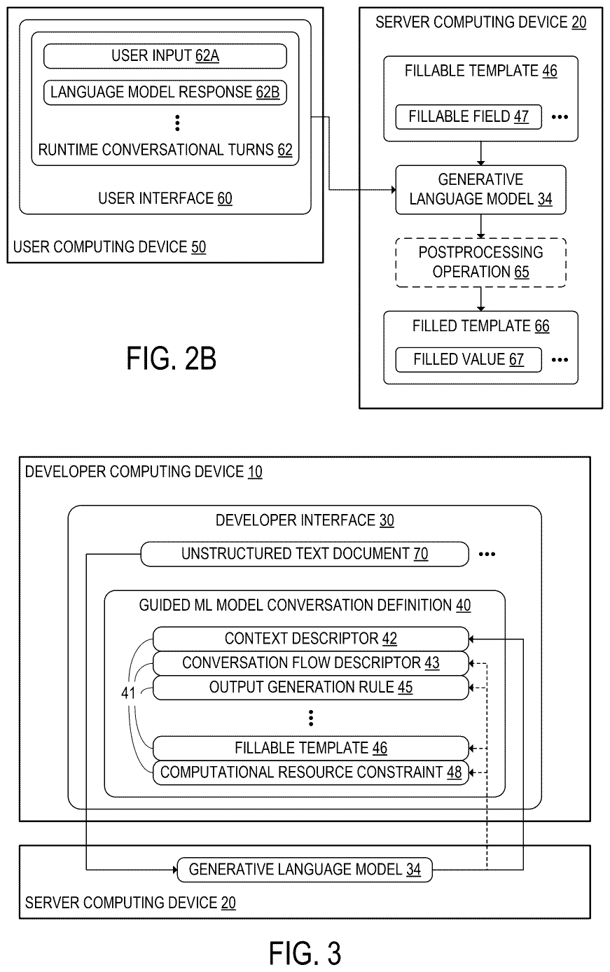

FIG. 2A schematically shows the computing system 1 when the one or more processing devices 22 of the server computing device 20 are configured to execute a guided conversation 64 between a user and the generative language model 34. This guided conversation 64 occurs subsequently to the computation of the guided ML model conversation definition 40 and is performed between the generative language model 34 and an end user. In the example of FIG. 2A, the server computing device 20 is configured to communicate with a user computing device 50 that includes one or more processing devices 52, one or more memory devices 54, one or more input devices 56, and one or more output devices 58. The user computing device 50 may be an end user computing device that is different from the developer computing device 10 shown in FIG. 1.

The guided conversation 64 is executed as specified by the definition components 41 included in the guided ML model conversation definition 40. Executing the guided conversation 64 includes exchanging a plurality of runtime conversational turns 62 between the user and the generative language model 34 at a user interface 60. The user interface 60 is executed at the one or more processing devices 52 of the user computing device 50 and allows the user to communicate with the generative language model 34 using the one or more input devices 56 and the one or more output devices 58. The plurality of runtime conversational turns 62 exchanged over the user interface 60 include a plurality of user inputs 62A and a plurality of language model responses 62B.

Returning to the example of FIG. 1, the definition components 41 are discussed in further detail. In the example of FIG. 1, the definition components 41 of the guided ML model conversation definition 40 include a context descriptor 42 of the guided conversation. The context descriptor 42 is a high-level descriptor of a scenario or environment in which the guided conversation is performed. For example, the context descriptor 42 may state the role of the user and the high-level actions the generative language model 34 is configured to take to assist the user. In some examples, the context descriptor 42 has a natural language format.

An example context descriptor 42 is provided as follows: “The user is a candidate applying for an Applied Scientist role at Microsoft. The goal of the automated conversation is to conduct an initial screening interview based on the Applied Scientist Screen Interview Guide to assess the candidate's qualifications, experience, and suitability for the role, and to determine whether the candidate can move onto the on-site interview loop.”

Another example context descriptor 42 is provided as follows: “The user is a customer requiring support with a product or service. The goal of the automated conversation is to identify the customer's issue, provide relevant information, solutions, or escalate the matter to a human representative if necessary.”

The definition components 41 shown in the example of FIG. 1 further include a conversation flow descriptor 43. The conversation flow descriptor 43 specifies a plurality of conversation stages 44 for inclusion in the guided conversation. The conversation flow descriptor 43 and its component conversation stages 44 may also have a natural language format in some examples. An example conversation stage 44 is “Ask whether the user has additional questions about the recommended solution to the technical support problem.” Another example conversation stage 44 is “Ask the user to identify each travel destination.” An example of a full set of conversation stages 44 is “Start by asking the user to describe their problem, then ask clarifying questions, then propose a recommended solution, then ask whether they have any questions about the recommended solution.”

The definition components 41 further include one or more output generation rules 45. The output generation rules 45 specify respective constraints on the outputs generated by the generative language model 34 during the guided conversation. Each of the one or more output generation rules 45 may be a negative constraint (inhibiting the generative language model 34 from generating output with a specific property) or a positive constraint (requiring the generative language model 34 to generate output with a specific property). The one or more output generation rules 45 may apply to the entire guided conversation or to particular conversation stages 44 indicated in the conversation flow descriptor 43. In some examples, the one or more output generation rules 45 have the natural language format. Additionally or alternatively, one or more of the output generation rules 45 may have a code format. For example, an output generation rule 45 may be code instructing the generative language model 34 to generate its language model response 62B as an image at a specific conversation stage 44. An example output generation rule 45 that has the natural language format is “Do not ask the user to share any passwords.” Another example output generation rule 45 is “Do allow the job candidate to ask detailed questions regarding recent projects undertaken at the company.”

The definition components 41 further include a fillable template 46, which includes a plurality of fillable fields 47. In addition to the fillable fields 47, the fillable template 46 may include a respective description of each fillable field 47 and/or a respective data type (e.g., string or integer) of each fillable field 47. The fillable template 46 may further include one or more respective formatting requirements (e.g., a regular expression or a range of eligible values) associated with one or more of the fillable fields 47.

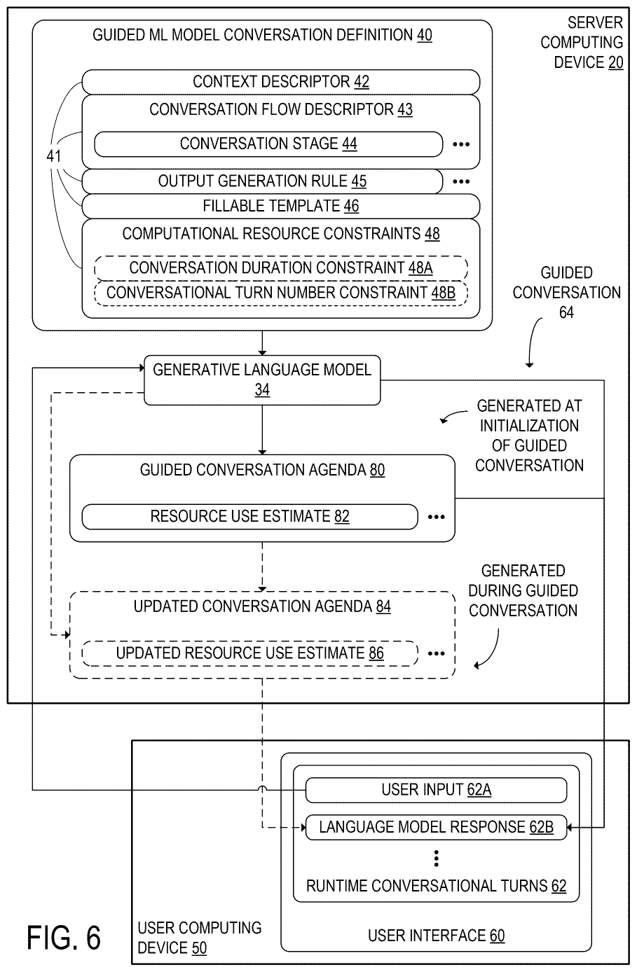

The definition components 41 further include a computational resource constraint 48. The computational resource constraint 48 may, for example, be a conversation duration constraint 48A or a conversational turn number constraint 48B, as discussed in further detail below with reference to FIG. 6. In other examples, the computational resource constraint 48 may be a constraint on some other quantity, such as a number of tokens generated at the generative language model 34 or an amount of GPU time used to execute the generative language model 34. Thus, the one or more computational resource constraints 48 may allow the generative language model 34 to avoid using large amounts of computational resources by engaging in an overly long guided conversation 64. The computational resource constraint 48 may alternatively constrain the generative language model 34 to use a full amount of a computational resource allotted to the generative language model 34.

As shown in the example of FIG. 2B, when the one or more processing devices 22 of the server computing device 20 and the one or more processing devices 52 of the user computing device 50 execute the guided conversation 64, the one or more processing devices 22 are further configured to fill the fillable template 46 based at least in part on the plurality of runtime conversational turns 62. The one or more processing devices 22 are configured to generate a filled template 66 including a plurality of filled values 67 of the fillable fields 47. The filled values 67 are generated at least in part at the generative language model 34. In some examples, one or more processing devices 22 are further configured to perform a postprocessing operation 65 on outputs of the generative language model 34 to produce filled values 67 that have respective formats specified in the fillable template 46.

FIG. 3 schematically shows the developer computing device 10 and the server computing device 20 in an example in which the one or more processing devices 22 are further configured to receive an unstructured text document 70 at the developer interface 30 during computation of the guided ML model conversation definition 40. In some examples, the one or more processing devices 12 are configured to receive a plurality of unstructured text documents 70 at the developer interface 30. The one or more processing devices 12 are further configured to transmit the one or more unstructured text documents 70 to the server computing device 20.

The one or more processing devices 22 of the server computing device 20 are further configured to extract the context descriptor 42 from the unstructured text document 70 at least in part by executing the generative language model 34. For example, the generative language model 34 may summarize the unstructured text document 70 to obtain the context descriptor 42. The one or more processing devices 22 are further configured to transmit the context descriptor 42 to the developer computing device 10. The developer may then accept, reject, or modify the context descriptor 42 at the developer interface 30. One or more other definition components 41, such as the conversation flow descriptor 43, the one or more output generation rules 45, and/or the computational resource constraint 48, may additionally or alternatively be computed at the generative language model 34 in some examples.

In some examples, the generative language model 34 may be configured to compress the unstructured text document 70 into the context descriptor 42 and/or one or more of the other definition components 41 prior to executing the plurality of development-time conversational turns 32. In other examples, the one or more processing devices 12 may be configured to maintain the unstructured text document 70 within the context window of the generative language model 34 at each of the development-time conversational turns 32.

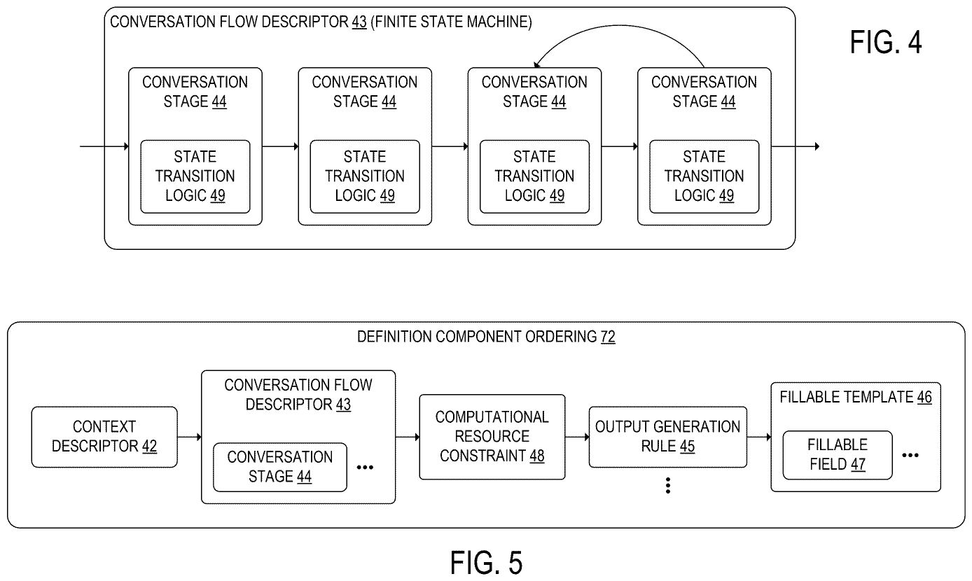

In some examples, as shown in FIG. 4, the conversation flow descriptor 43 may be a finite state machine. In the finite state machine, the conversation stages 44 are states. FIG. 4 schematically shows an example conversation flow descriptor 43 including a plurality of conversation stages 44 connected by a plurality of state transitions. In this example, during the guided conversation 64, the one or more processing devices 22 are configured to transition between the conversation stages 44 according to respective state transition logic 49 included in each of the conversation stages 44.

FIG. 5 schematically shows an example in which, over the plurality of development-time conversational turns 32, the processing devices 12 and 22 are configured to compute the definition components 41 in a specific definition component ordering 72. This definition component ordering 72 includes first computing the context descriptor 42. The definition component ordering 72 further includes computing the conversation flow descriptor 43 after the context descriptor 42, computing the computational resource constraint 48 after the conversation flow descriptor 43, computing the one or more output generation rules 45 after the computational resource constraint 48, and computing the fillable template 46 after the one or more output generation rules 45. Computing the definition components 41 in the above definition component ordering 72 may make it less likely that the developer has to backtrack within the process of generating the guided ML model conversation definition 40 to modify earlier-generated definition components 41. For example, the generation of the specific conversation stages 44 included in the conversation flow descriptor 43 are likely to be influenced by the contextual information provided in the context descriptor 42, whereas the conversation stages 44 are less likely to influence the generation of that contextual information. Thus, the guided ML model conversation definition 40 may be computed in a faster and more efficient manner by generating the definition components 41 in the definition component ordering 72 of FIG. 5.

FIG. 6 schematically shows the server computing device 20 and the user computing device 50 in an example in which the one or more processing devices 22 are further configured to generate a guided conversation agenda 80 during execution of the guided conversation 64. The guided conversation agenda 80 is generated at least in part at the generative language model 34 and includes at least one resource use estimate 82. The at least one resource use estimate 82 indicates an amount of a computational resource specified by the computational resource constraint 48.

In examples in which the guided ML model conversation definition 40 includes a conversation flow descriptor 43, the generative language model 34 may generate the at least one resource use estimate 82 as an estimate of an amount of the computational resource used in at least one of the conversation stages 44. For example, when the computational resource constraint 48 is a conversation duration constraint 48A, the one or more processing devices 22 may be configured to generate resource use estimates 82 indicating respective amounts of time the generative language model 34 estimates will be used in the different conversation stages 44. When the one or more computational resource constraints 48 include a conversational turn number constraint 48B, the resource use estimates 82 may be respective numbers of conversational turns estimated to be used in the different conversation stages 44.

In other examples, such as those in which the guided ML model conversation definition 40 does not include a conversation flow descriptor 43, the at least one resource use estimate 82 may be independent of conversation stages 44. For example, the one or more processing devices 22 may be configured to generate a single resource use estimate 82 that indicates an amount of the computational resource estimated to be used in a remaining portion of the guided conversation 64. As another example, the generative language model 34 may be configured to generate a plurality of resource use estimates 82 that have finer granularity than the conversation stages 44 included in the conversation flow descriptor 43.

The guided conversation agenda 80 may be structured as a filled template that includes a list of strings that label the conversation stages 44, and further includes respective estimated numbers of runtime conversational turns 62 assigned to those conversation stages 44. For example, the following guided conversation agenda may be used when the guided conversation 64 is performed during a job interview for a customer service position:
1. Greet the candidate and provide an overview of the interview: 1 turn
2. Discuss the candidate's previous experiences with customer service: 2 turns
3. Discuss a hypothetical scenario about a challenging customer: 2 turns
4. Ask follow-up questions or suggest additional scenarios based on the candidate's responses: 2 turns
5. Ask the candidate to share their strengths and weaknesses: 2 turns
6. Answer any remaining questions from the candidate: 2 turns

During the plurality of runtime conversational turns 62, the one or more processing devices 22 are further configured to allocate the computational resource based at least in part on the at least one resource use estimate 82 included in the guided conversation agenda 80. The guided conversation agenda 80 may be input into the generative language model 34 as a portion of the prompt. For example, the generative language model 34 may refer to the guided conversation agenda 80 at each runtime conversational turn 62 when determining whether to advance to the next conversational stage 44. Thus, the generative language model 34 is configured to schedule its outputs according to the estimated amounts of the computational resources specified in the guided conversation agenda 80, thereby allowing the one or more processing devices 22 to meet the one or more computational resource constraints 48 of the overall guided conversation 64.

In some examples, the one or more processing devices 22 are further configured to iteratively recompute the guided conversation agenda 80 during execution of the guided conversation 64. For example, when a conversation stage 44 uses a smaller amount of a computational resource than was estimated for that conversation stage 44 in the guided conversation agenda 80, the one or more processing devices 22 may be further configured to compute an updated conversation agenda 84 after that conversation stage 44 ends. As another example, when the computational resource constraint 48 specifies an exact amount of the computational resource, the one or more processing devices 22 may be configured to update the guided conversation agenda 80 in response to determining that the generative language model 34 has used either a larger or smaller amount of that computational resource than expected. The updated conversation agenda 84 may include one or more updated resource use estimates 86.

The generative language model 34 is further configured to compute the one or more language model responses 62B according to the one or more updated resource use estimates 86. The one or more processing devices 22 are accordingly configured to dynamically reallocate computational resources during the guided conversation 64. In some examples, the prompt of the generative language model 34 may include instructions to check the accuracy of the guided conversation agenda 80 at each runtime conversational turn 62, and to update the guided conversation agenda 80 if the stage specific resource use estimates 82 are inaccurate.

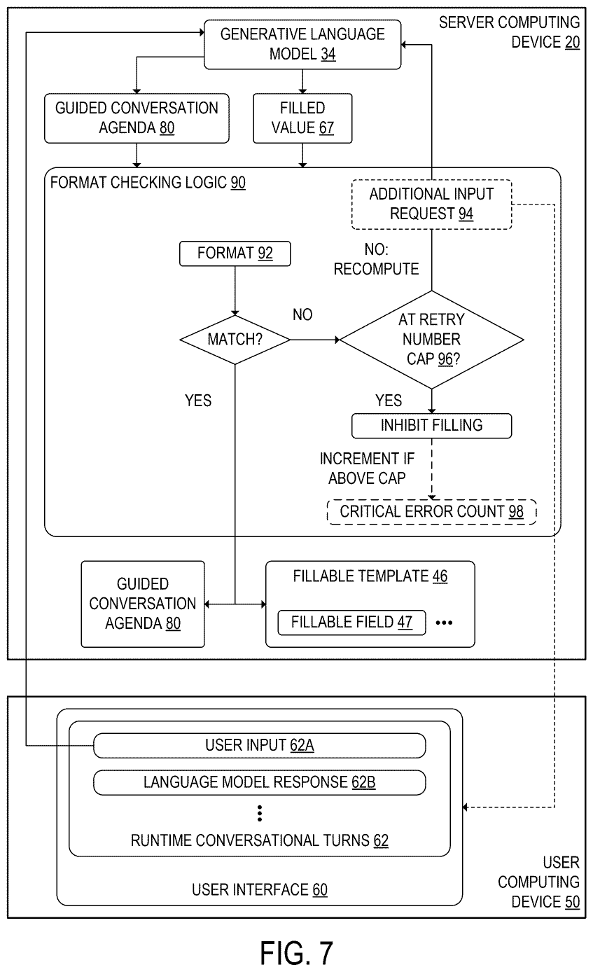

FIG. 7 schematically shows the server computing device 20 and the user computing device 50 in an example in which the one or more processing devices 22 are further configured to execute format checking logic 90. At the format checking logic 90, the one or more processing devices 22 may be further configured to determine that a filled value 67 of a corresponding fillable field 47 does not match a format 92 specified for the fillable field 47 in the fillable template 46. For example, the fillable template 46 may specify that the filled value 67 of a fillable field 47 is a string or a numerical value. As another example, the fillable template 46 may specify the format 92 using a regular expression.

In response to determining that the filled value 67 does not match the format 92, the one or more processing devices 22 may be further configured to recompute the filled value 67 at the generative language model 34. Alternatively, the one or more processing devices 22 may be configured to output an additional input request 94 to the user interface 60. In such examples, the additional input request 94 is a language model response 62B included among the plurality of runtime conversational turns 62. For example, when the generative language model 34 fills a fillable field 47 with data received in a user input 62A, but the user input 62A does not include a sufficient level of detail to compute a filled value 67 that matches the specified format 92, the additional input request 94 may be a request for an additional user input that includes further information with which the generative language model 34 recomputes the filled value 67.

In the example of FIG. 7, the format checking logic 90 is also applied to the guided conversation agenda 80. In examples in which the guided conversation agenda 80 does not match a predetermined format 92, the one or more processing devices 22 are further configured to recompute the guided conversation agenda 80 at the generative language model 34.

In some examples, as shown in FIG. 7, the guided ML model conversation definition 40 may include a retry number cap 96 associated with the fillable field 47. The retry number cap 96 is a maximum number of times the generative language model 34 is configured to recompute the filled value 67 when the filled value 67 does not match the format 92. The one or more processing devices 22 may be further configured to determine that the generative language model 34 has recomputed the filled value 67 a number of times equal to the retry number cap 96. In response to determining that the generative language model 34 has recomputed the filled value 67 the number of times equal to the retry number cap 96, the one or more processing devices 22 are further configured to inhibit the generative language model 34 from filling the fillable field 47 in one or more subsequent runtime conversational turns 62 of the guided conversation 64.

After the retry number cap 96 has been reached, if the one or more processing devices 22 make another attempt to fill that fillable field 47, the one or more processing devices 22 may be further configured to increment a critical error count 98. If the critical error count 98 reaches a critical error threshold, the one or more processing devices 22 may be further configured to terminate the guided conversation 64. Other examples of critical errors may include failing to select an action during a runtime conversational turn 62; selecting an invalid action (e.g., an action other than outputting a language model response 62B, filling a fillable field 47, updating the guided conversation agenda 80, or terminating the guided conversation 64); and selecting a valid action without specifying valid parameters (e.g., attempting to fill a nonexistent fillable field). In some examples, the one or more processing devices 22 may be further configured to report critical errors that occur during the runtime conversation 64 to the developer computing device 10.

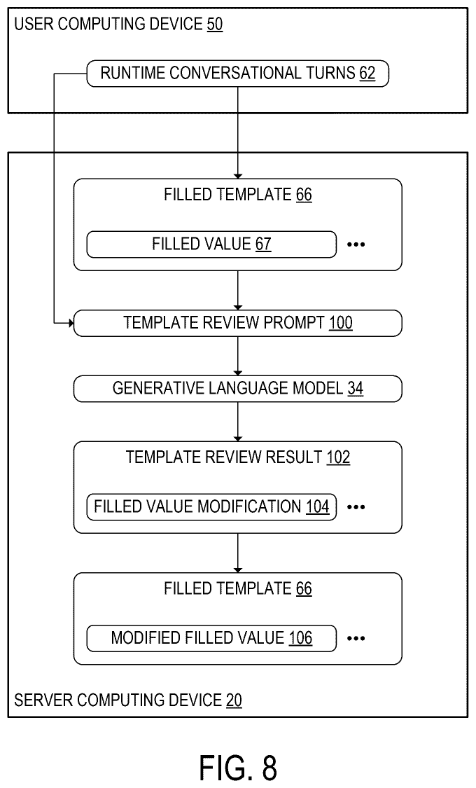

In some examples, as shown in FIG. 8, the one or more processing devices 22 are further configured to perform a review of the filled template 66 at the generative language model 34. This review is performed subsequently to a final conversational turn 62 of the plurality of runtime conversational turns 62. Based at least in part on the filled template 66, the one or more processing devices 22 are further configured to compute a template review prompt 100 and input the template review prompt 100 into the generative language model 34. For example, the template review prompt 100 may include instructions for the generative language model 34 to check the filled template 66 for errors and for additional filled values 67 that could be added. The runtime conversational turns 62, or a summary thereof, may also be included in the template review prompt 100.

At the generative language model 34, the one or more processing devices 22 are configured to compute a template review result 102. The template review result 102 may include one or more filled value modifications 104. The one or more filled value modifications 104 may be one or more corrections to errors, and/or one or more additional filled values 67. Alternatively, the template review result 102 may indicate that the filled template 66 is left unchanged.

In examples in which the template review result 102 includes one or more filled value modifications 104, the one or more processing devices 22 may be further configured to modify one or more filled values 67 of one or more respective fillable fields 47 of the filled template 66 based at least in part on the template review result 102. One or more modified filled values 106 of the filled template 66 may be computed at the generative language model 34. Thus, the one or more processing devices 22 are configured to prepare the filled template 66 for output following the plurality of runtime conversational turns 62.

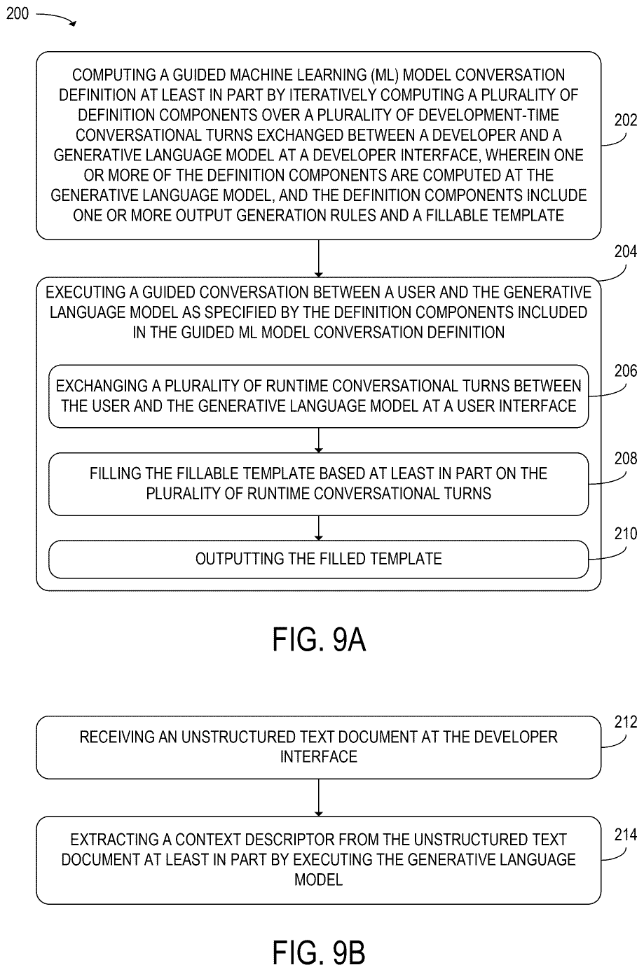

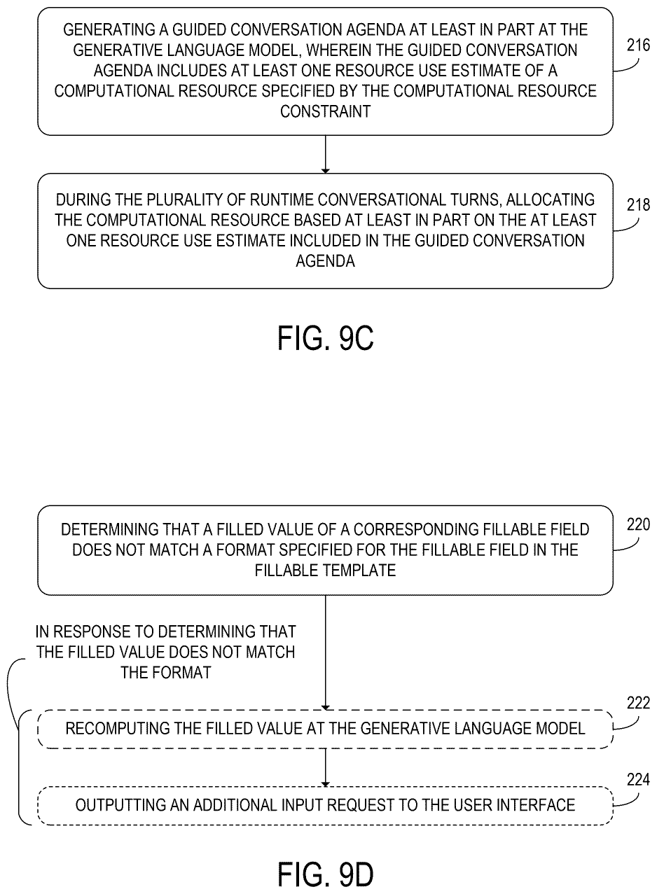

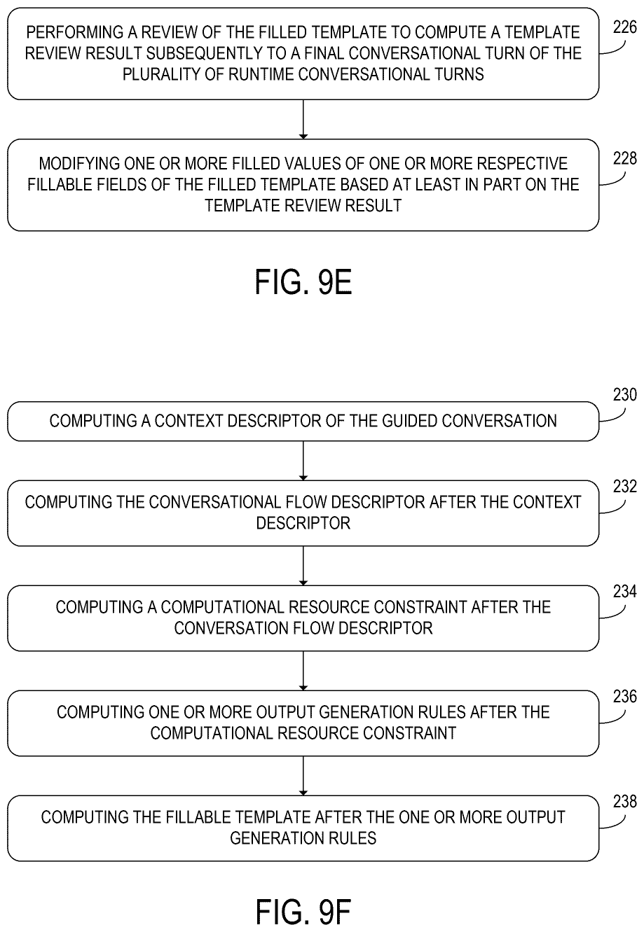

FIG. 9A shows a flowchart of a method 200 for use with a computing system to compute and execute a guided ML model conversation definition. At step 202, the method 200 includes computing the guided ML model conversation definition at least in part by iteratively computing a plurality of definition components. These definition components are computed over a plurality of development-time conversational turns exchanged between a developer and a generative language model at a developer interface. For example, the developer interface may be executed at a developer computing device that communicates over a network with a server computing device at which the generative language model is executed. One or more of the definition components are computed at the generative language model. In some examples, one or more of the definition components may be developer inputs.

In some examples, the definition components computed at step 202 include a context descriptor of the guided conversation. The context descriptor may, for example, state a user role and a task with which the generative language model assists the user. The definition components computed at step 202 may further include a conversation flow descriptor that specifies a plurality of conversation stages. These conversation stages may be specified with text descriptors in a natural language format. The plurality of definition components further include one or more output generation rules, which may also be computed as having a natural language format. One or more of the output generation rules may additionally or alternatively have a code format. The plurality of definition components further include a fillable template that includes a plurality of fillable fields. Respective text descriptions, data types, and/or formatting criteria associated with the fillable fields may also be included in the fillable template in some examples. The plurality of definition components may further include a computational resource constraint. For example, the computational resource constraint may be a conversation duration constraint or a conversational turn number constraint. A constraint on some other computational resource, such as a number of tokens generated at the generative language model, may alternatively be used in some examples.

At step 204, the method 200 further includes executing a guided conversation between a user and the generative language model as specified by the definition components included in the guided ML model conversation definition. Executing the guided conversation includes, at step 206, exchanging a plurality of runtime conversational turns between the user and the generative language model at a user interface. Each of the runtime conversational turns is a user input or a language model response. The user interface may be executed at a user computing device that is configured to communicate with the server computing device.

At step 208, executing the guided conversation at step 204 further includes filling the fillable template based at least in part on the plurality of runtime conversational turns. When step 208 is performed, the user inputs included in the guided conversation are processed at the generative language model to compute respective filled values of the fillable fields included in the fillable template.

At step 210, executing the guided conversation at step 204 further includes outputting the filled template. In some examples, the filled template is output to the user interface. Additionally or alternatively, the filled fields of the fillable template may be used as an input to some other computing process.

FIGS. 9B-9F show additional steps of the method 200 that may be performed in some examples. The steps shown in FIG. 9B may be performed when computing the guided ML model conversation definition at step 202. The definition components further include a context descriptor of the guided conversation in the example of FIG. 9B. At step 212, step 202 may further include receiving an unstructured text document at the developer interface. For example, the unstructured text document may be a prior example of a task that the developer intends to have the generative language model perform during the guided conversation. At step 214, step 202 may further include extracting the context descriptor from the unstructured text document at least in part by executing the generative language model. For example, the generative language model may summarize the unstructured text document to extract the context descriptor. Other definition components, such as the conversation flow descriptor, the one or more output generation rules, and/or the computational resource constraint, may also be extracted from the unstructured text document in some examples.

FIG. 9C shows additional steps that may be performed in some examples when executing the guided conversation at step 204. At step 216, the method 200 may further include generating a guided conversation agenda at least in part at the generative language model. The guided conversation agenda includes at least one resource use estimate of a computational resource specified by the computational resource constraint. For example, the resource use estimates may indicate amounts of time or numbers of conversational turns estimated to be used by the different conversation stages. In other examples, the at least one resource use estimate may be associated with the guided conversation as a whole, or with at least one portion of the guided conversation other than a conversation stage.

At step 218, during the plurality of runtime conversational turns, step 204 may further include allocating the computational resource based at least in part on the at least one resource use estimate included in the guided conversation agenda. The generative language model may, for example, generate its outputs in a manner that approximately matches the amounts of the computational resource used at the different conversational turns to the amounts predicted in the guided conversation agenda. In some examples, the estimates included in the guided conversation agenda may be updated at the generative language model during the guided conversation.

FIG. 9D shows steps that may be performed in some examples when computing the filled template at step 204. At step 220, step 204 may further include determining that a filled value of a corresponding fillable field does not match a format specified for the fillable field in the fillable template. In response to determining that the filled value does not match the format, step 204 may further include, at step 222, recomputing the filled value at the generative language model. Additionally or alternatively, at step 224, step 204 may further include outputting an additional input request to the user interface.

FIG. 9E shows additional steps that may be performed at the generative language model when filling the fillable template at step 204. At step 226, subsequently to a final conversational turn of the plurality of runtime conversational turns, step 204 may further include performing a review of the filled template to compute a template review result. Performing the review of the filled template may include generating a template review prompt based at least in part on the filled template and inputting that template review prompt into the generative language model. The template review result may include one or more filled value modifications, which may be error identifications or additional filled values. At step 228, step 204 may further include modifying one or more filled values of one or more respective fillable fields of the filled template based at least in part on the template review result. Thus, the generative language model may correct one or more errors detected in the filled template or insert additional filled values extracted during the review.

FIG. 9F shows steps that may be performed at step 202 during computation of the guided ML model conversation description. Over the plurality of development-time conversational turns, the definition components may be computed in a definition component ordering that includes, at step 230, computing a context descriptor 230 of the guided conversation. At step 232, the definition component ordering may further include computing the conversational flow descriptor after the context descriptor. At step 234, step 202 may further include computing the a computational resource constraint after the conversation flow descriptor. At step 236, step 202 may further include computing one or more output generation rules after the computational resource constraint 234. At step 238, step 202 may further include computing the fillable template after the one or more output generation rules. Computing the definition components in the above ordering may reduce the amount of backtracking performed in the plurality of development-time conversational turns to revise previously defined definition components.

Using the devices and methods discussed above, a guided conversation is performed between a developer and a generative language model to produce a guided ML model conversation definition for another guided conversation. The devices and methods discussed above may thereby allow the developer to more quickly and easily develop an ML application that utilizes a guided conversation structure. A wide variety of tasks utilizing generative language models can be framed as template-filling tasks. The devices and methods discussed above are therefore widely applicable in generative language model application development.

Generative language models tend to exhibit a flexibility-reliability tradeoff. During the plurality of development-time conversational turns, the fillable template may also allow the developer to more easily control the level of flexibility exhibited by the generative language model in the ML application. The developer may use the approaches discussed above to generate multiple different guided ML model conversation definitions that have different levels of flexibility. By testing the different guided ML model conversation definitions, the developer may select a guided ML model conversation definition that closely matches an intended flexibility level.

Structuring the guided conversation as a template-filling task may also increase the reliability and goal-orientation of the content computed at the generative language model, even without significantly decreasing flexibility. The fillable template indicates, in a structurally consistent manner, the developer's intended properties of the outputs of the guided conversation, thereby guiding the generative language model toward computing outputs with the specified properties. In addition, by referring to a partially filled template during the guided conversation, the generative language model may track which fillable fields have already been completed. The fillable template may accordingly act as a form of working memory for the generative language model and may keep the generative language model on-task more reliably.

The methods and processes described herein are tied to a computing system of one or more computing devices. In particular, such methods and processes can be implemented as a computer-application program or service, an application-programming interface (API), a library, and/or other computer-program product.

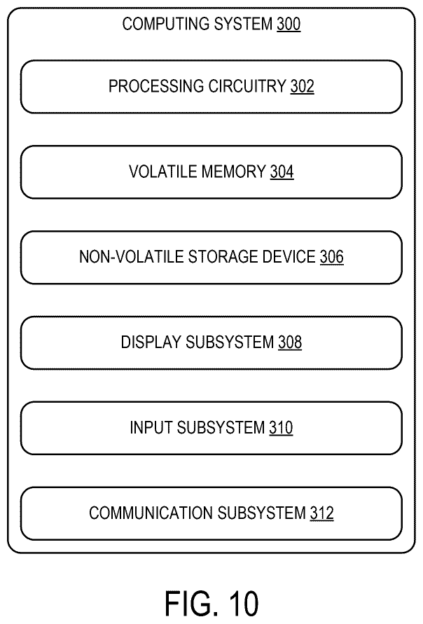

FIG. 10 schematically shows a non-limiting embodiment of a computing system 300 that can enact one or more of the methods and processes described above. Computing system 300 is shown in simplified form. Computing system 300 may embody the computing system 1 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 10.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to compute a guided ML model conversation definition at least in part by iteratively computing a plurality of definition components over a plurality of development-time conversational turns exchanged between a developer and a generative language model at a developer interface. One or more of the definition components are computed at the generative language model. The definition components include one or more output generation rules and a fillable template. The one or more processing devices are further configured to execute a guided conversation between a user and the generative language model as specified by the definition components included in the guided ML model conversation definition. Executing the guided conversation includes exchanging a plurality of runtime conversational turns between the user and the generative language model at a user interface. Executing the guided conversation further includes filling the fillable template based at least in part on the plurality of runtime conversational turns. Executing the guided conversation further includes outputting the filled template. The above features may have the technical effect of performing a guided conversation between a developer and a generative language model to compute a definition of another guided conversation.

According to this aspect, the definition components may further include a context descriptor of the guided conversation. The above feature may have the technical effect of providing a high-level descriptor of a scenario or environment in which the guided conversation is performed.

According to this aspect, the one or more processing devices may be further configured to receive an unstructured text document at the developer interface. The one or more processing devices may be further configured to extract the context descriptor from the unstructured text document at least in part by executing the generative language model. The above features may have the technical effect of programmatically computing the context descriptor.

According to this aspect, the definition components may further include a computational resource constraint. The computational resource constraint may be a conversation duration constraint or a conversational turn number constraint. The above features may have the technical effect of defining an amount of a computational resource that is used during the guided conversation.

According to this aspect, the definition components may further include a conversation flow descriptor that specifies a plurality of conversation stages. The one or more processing devices may be further configured to generate a guided conversation agenda at least in part at the generative language model. The guided conversation agenda may include at least one resource use estimate of a computational resource specified by the computational resource constraint. During the plurality of runtime conversational turns, the one or more processing devices may be further configured to allocate the computational resource based at least in part on the at least one resource use estimate included in the guided conversation agenda. The above features may have the technical effect of scheduling expenditures of the computational resource over the course of the guided conversation.

According to this aspect, filling the fillable template may further include determining that a filled value of a corresponding fillable field does not match a format specified for the fillable field in the fillable template. Filling the fillable template may further include, in response to determining that the filled value does not match the format, recomputing the filled value at the generative language model or outputting an additional input request to the user interface. The above features may have the technical effect of correcting a type error in the fillable field.

According to this aspect, the guided ML model conversation definition may include a retry number cap associated with the fillable field. The one or more processing devices may be further configured to determine that the generative language model has recomputed the filled value a number of times equal to the retry number cap. In response to determining that the generative language model has recomputed the filled value the number of times equal to the retry number cap, the one or more processing devices may be further configured to inhibit the generative language model from filling the fillable field in one or more subsequent runtime conversational turns of the guided conversation. The above features may have the technical effect of inhibiting further attempts to fill the fillable field when the generative language model repeatedly computes invalid filled values.

According to this aspect, filling the fillable template may further include, at the generative language model, performing a review of the filled template to compute a template review result subsequently to a final conversational turn of the plurality of runtime conversational turns. Filling the fillable template may further include modifying one or more filled values of one or more respective fillable fields of the filled template based at least in part on the template review result. The above features may have the technical effect of correcting errors in the filled template.

According to this aspect, the definition components may further include a conversation flow descriptor that specifies a plurality of conversation stages. The above feature may have the technical effect of dividing the guided conversation into conversation stages with different topics and/or objectives.

According to this aspect, the conversation flow descriptor and the one or more output generation rules may have a natural language format. The above features may have the technical effect of specifying the conversation flow descriptor and the one or more output generation rules in a manner that is user-interpretable and can be processed at the generative language model.

According to this aspect, the conversation flow descriptor may be a finite state machine in which the conversation stages are states. The above features may have the technical effect of specifying the progression of the guided conversation between the conversation stages.

According to this aspect, over the plurality of development-time conversational turns, the one or more processing devices may be configured to compute the definition components in a definition component ordering that includes computing a computational resource constraint after the conversation flow descriptor. The definition ordering may further include computing the one or more output generation rules after the computational resource constraint. The definition ordering may further include computing the fillable template after the one or more output generation rules. The above features may have the technical effect of reducing backtracking during the generation of the guided ML model conversation definition.

According to another aspect of the present disclosure, a method for use with a computing system is provided. The method includes computing a guided ML model conversation definition at least in part by iteratively computing a plurality of definition components over a plurality of development-time conversational turns exchanged between a developer and a generative language model at a developer interface. One or more of the definition components are computed at the generative language model. The definition components include one or more output generation rules and a fillable template. The method further includes executing a guided conversation between a user and the generative language model as specified by the definition components included in the guided ML model conversation definition. Executing the guided conversation includes exchanging a plurality of runtime conversational turns between the user and the generative language model at a user interface. Executing the guided conversation further includes filling the fillable template based at least in part on the plurality of runtime conversational turns. Executing the guided conversation further includes outputting the filled template. The above features may have the technical effect of performing a guided conversation between a developer and a generative language model to compute a definition of another guided conversation.

According to this aspect, the definition components may further include a context descriptor of the guided conversation. The above feature may have the technical effect of providing a high-level descriptor of a scenario or environment in which the guided conversation is performed.

According to this aspect, the definition components may further include a computational resource constraint. The computational resource constraint may be a conversation duration constraint or a conversational turn number constraint. The above features may have the technical effect of defining an amount of a computational resource that is used during the guided conversation.

According to this aspect, the method may further include generating a guided conversation agenda at least in part at the generative language model. The guided conversation agenda may include at least one resource use estimate of a computational resource specified by the computational resource constraint. During the plurality of runtime conversational turns, the method may further include allocating the computational resource based at least in part on the at least one resource use estimate included in the guided conversation agenda. The above features may have the technical effect of scheduling expenditures of the computational resource over the course of the guided conversation.

According to this aspect, filling the fillable template may further include determining that a filled value of a corresponding fillable field does not match a format specified for the fillable field in the fillable template. In response to determining that the filled value does not match the format, filling the fillable template may further include recomputing the filled value at the generative language model or outputting an additional input request to the user interface. The above features may have the technical effect of correcting a type error in the fillable field.

According to this aspect, the definition components may further include a conversation flow descriptor that specifies a plurality of conversation stages. The above feature may have the technical effect of dividing the guided conversation into conversation stages with different topics and/or objectives.

According to another aspect of the present disclosure, a computing system is provided, including one or more processing devices configured to compute a guided ML model conversation definition at least in part by iteratively computing a plurality of definition components over a plurality of development-time conversational turns exchanged between a developer and a generative language model at a developer interface. One or more of the definition components are computed at the generative language model. The definition components include a context descriptor of the guided conversation, a conversation flow descriptor that specifies a plurality of conversation stages and is computed after the context descriptor, a computational resource constraint computed after the conversation flow descriptor, one or more output generation rules computed after the computational resource constraint, and a fillable template computed after the one or more output generation rules. The one or more processing devices are further configured to execute a guided conversation between a user and the generative language model as specified by the definition components included in the guided ML model conversation definition. Executing the guided conversation includes exchanging a plurality of runtime conversational turns between the user and the generative language model at a user interface. Executing the guided conversation further includes filling the fillable template based at least in part on the plurality of runtime conversational turns. Executing the guided conversation further includes outputting the filled template. The above features may have the technical effect of performing a guided conversation between a developer and a generative language model to compute a definition of another guided conversation.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
compute a guided machine learning (ML) model conversation definition at least in part by iteratively computing a plurality of definition components over a plurality of development-time conversational turns exchanged between a developer and a generative language model at a developer interface, wherein:
one or more of the definition components are computed at the generative language model; and
the definition components include one or more output generation rules and a fillable template; and
execute a guided conversation between a user and the generative language model as specified by the definition components included in the guided ML model conversation definition, wherein executing the guided conversation includes:
exchanging a plurality of runtime conversational turns between the user and the generative language model at a user interface;
filling the fillable template based at least in part on the plurality of runtime conversational turns; and
outputting the filled template.

2. The computing system of claim 1, wherein the definition components further include a context descriptor of the guided conversation.

3. The computing system of claim 2, wherein the one or more processing devices are further configured to:
receive an unstructured text document at the developer interface; and
extract the context descriptor from the unstructured text document at least in part by executing the generative language model.

4. The computing system of claim 1, wherein:
the definition components further include a computational resource constraint; and
the computational resource constraint is a conversation duration constraint or a conversational turn number constraint.

5. The computing system of claim 4, wherein:
the definition components further include a conversation flow descriptor that specifies a plurality of conversation stages; and
the one or more processing devices are further configured to:
generate a guided conversation agenda at least in part at the generative language model, wherein the guided conversation agenda includes at least one resource use estimate of a computational resource specified by the computational resource constraint; and
during the plurality of runtime conversational turns, allocate the computational resource based at least in part on the at least one resource use estimate included in the guided conversation agenda.

6. The computing system of claim 1, wherein filling the fillable template further includes:
determining that a filled value of a corresponding fillable field does not match a format specified for the fillable field in the fillable template; and
in response to determining that the filled value does not match the format:
recomputing the filled value at the generative language model; or
outputting an additional input request to the user interface.

7. The computing system of claim 6, wherein:
the guided ML model conversation definition includes a retry number cap associated with the fillable field;
the one or more processing devices are further configured to:
determine that the generative language model has recomputed the filled value a number of times equal to the retry number cap; and
in response to determining that the generative language model has recomputed the filled value the number of times equal to the retry number cap, inhibit the generative language model from filling the fillable field in one or more subsequent runtime conversational turns of the guided conversation.

8. The computing system of claim 1, wherein filling the fillable template further includes, at the generative language model:
performing a review of the filled template to compute a template review result subsequently to a final conversational turn of the plurality of runtime conversational turns; and
modifying one or more filled values of one or more respective fillable fields of the filled template based at least in part on the template review result.

9. The computing system of claim 1, wherein the definition components further include a conversation flow descriptor that specifies a plurality of conversation stages.

10. The computing system of claim 9, wherein the conversation flow descriptor and the one or more output generation rules have a natural language format.

11. The computing system of claim 9, wherein the conversation flow descriptor is a finite state machine in which the conversation stages are states.

12. The computing system of claim 9, wherein, over the plurality of development-time conversational turns, the one or more processing devices are configured to compute the definition components in a definition component ordering that includes:
computing a computational resource constraint after the conversation flow descriptor;
computing the one or more output generation rules after the computational resource constraint; and
computing the fillable template after the one or more output generation rules.

13. A method for use with a computing system, the method comprising:
computing a guided machine learning (ML) model conversation definition at least in part by iteratively computing a plurality of definition components over a plurality of development-time conversational turns exchanged between a developer and a generative language model at a developer interface, wherein:
one or more of the definition components are computed at the generative language model; and
the definition components include one or more output generation rules and a fillable template; and
executing a guided conversation between a user and the generative language model as specified by the definition components included in the guided ML model conversation definition, wherein executing the guided conversation includes:
exchanging a plurality of runtime conversational turns between the user and the generative language model at a user interface;
filling the fillable template based at least in part on the plurality of runtime conversational turns; and
outputting the filled template.

14. The method of claim 13, wherein the definition components further include a context descriptor of the guided conversation.

15. The method of claim 14, further comprising:
receiving an unstructured text document at the developer interface; and
extracting the context descriptor from the unstructured text document at least in part by executing the generative language model.

16. The method of claim 13, wherein:
the definition components further include a computational resource constraint; and
the computational resource constraint is a conversation duration constraint or a conversational turn number constraint.

17. The method of claim 16, further comprising:
generating a guided conversation agenda at least in part at the generative language model, wherein the guided conversation agenda includes at least one resource use estimate of a computational resource specified by the computational resource constraint; and
during the plurality of runtime conversational turns, allocating the computational resource based at least in part on the at least one resource use estimate included in the guided conversation agenda.

18. The method of claim 13, wherein filling the fillable template further includes:
determining that a filled value of a corresponding fillable field does not match a format specified for the fillable field in the fillable template; and
in response to determining that the filled value does not match the format:
recomputing the filled value at the generative language model; or
outputting an additional input request to the user interface.

19. The method of claim 13, wherein the definition components further include a conversation flow descriptor that specifies a plurality of conversation stages.

20. A computing system comprising:
one or more processing devices configured to:
compute a guided machine learning (ML) model conversation definition at least in part by iteratively computing a plurality of definition components over a plurality of development-time conversational turns exchanged between a developer and a generative language model at a developer interface, wherein:
one or more of the definition components are computed at the generative language model; and
the definition components include:
a context descriptor of the guided conversation;
a conversation flow descriptor that specifies a plurality of conversation stages and is computed after the context descriptor;
a computational resource constraint computed after the conversation flow descriptor;
one or more output generation rules computed after the computational resource constraint; and
a fillable template computed after the one or more output generation rules; and
execute a guided conversation between a user and the generative language model as specified by the definition components included in the guided ML model conversation definition, wherein executing the guided conversation includes:
exchanging a plurality of runtime conversational turns between the user and the generative language model at a user interface;
filling the fillable template based at least in part on the plurality of runtime conversational turns; and
outputting the filled template.
